(19) United States
(12) Patent Application Publication
(10) Pub. No.: US 2018/0365615 A1
(43) Pub. Date: Dec. 20, 2018

(54) Contest Systems and Methods

(71) Applicants: Anthony John Pease, Cary, NC (US); Brandon Eric Phillips, Boulder, CO (US); Sarah Elizabeth Deasy, Raleigh, NC (US); Bryan Gregory Martin, Raleigh, NC (US); Daniel Shugan, Raleigh, NC (US)

(72) Inventors: Anthony John Pease, Cary, NC (US); Brandon Eric Phillips, Boulder, CO (US); Sarah Elizabeth Deasy, Raleigh, NC (US); Bryan Gregory Martin, Raleigh, NC (US); Daniel Shugan, Raleigh, NC (US)

(21) Appl. No.: 15/881,813

(22) Filed: Jan. 29, 2018

Related U.S. Application Data
(60) Provisional application No. 62/520,567, filed on Jun. 16, 2017.

(51) Int. Cl. G06Q 10/06

(52) U.S. Cl. CPC G06Q 10/06311; G06Q 50/10

(57) ABSTRACT

The invention provides a method comprising selecting a challenger, an opponent, an event, a first and second outcome of an event, a charity, and an amount to form a wager, wherein the first outcome is associated with the challenger and the second outcome is associated with the opponent, wherein the first and second outcomes are not identical; communicating the wager to the opponent; receiving a response to the wager by the opponent; determining whether the first or second outcome occurs; notifying challenger and opponent of the outcome; receiving a first payment by the challenger if the second outcome occurs or by opponent if the first outcome occurs; and sending a second payment to the charity.

### RELATED APPLICATIONS

This application claims priority to U.S. Provisional Application No. 62/520,567 filed Jun. 16, 2017, which is hereby incorporated in its entirety.

### FIELD OF THE INVENTION

The present invention relates generally to systems and methods for facilitating contests, and in particular system and methods for creating contest challenges incentivizing charitable donations.

### BACKGROUND OF THE INVENTION

Many individuals like to donate or contribute to charitable organizations and events, and are often incentivized to do so by the fulfillment and positive feelings they receive in return. Further, sporting events, competitions, and other events with discrete outcomes attract the attention and resources of individuals seeking entertainment and the fulfillment associated with being on the winning side.

Using the popularity and excitement of competitive events to raise awareness and resources for charitable causes has a long tradition and is ubiquitous amongst professional sports franchises. Each city and league has causes associated with their teams and events. Notwithstanding the local bingo or poker night, there are few resources that combine the enthusiasm for competition and the fulfillment of donating to a charitable cause.

There remains a need for systems and methods that permit gamification and of charitable causes and the ability to create challenges amongst donors, providing users with the thrill of competition and the fulfillment of aiding a charitable cause. Disclosed herein are one or more systems and methods that advantageously address these issues.

### SUMMARY OF THE INVENTION

One aspect of the present invention provides a method comprising: see claims.

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

According to at least one embodiment of the invention, a method of effecting a charitable donation is provided. The method includes: retrieving settings corresponding to a challenge, the settings including a challenge type, at least one event each having at least two possible outcomes, at least one charity, and at least one amount; storing a response corresponding to each of at least two users, at least two responses including an acceptance of the challenge, a selection of one of the at least two possible outcomes and a selection of another of the at least two possible outcomes; comparing at least one received actual outcome to each selected outcome, wherein the at least one actual income is one of the at least two possible outcomes; awarding points to each of the users based on the comparing; and effecting a donation to one of the at least one charity based on the awarding.

According to at least another embodiment of the invention, the method further includes: identifying one of the at least two users as a challenger and each remaining users as an opponent; modifying the settings using responses associated with the challenger; and communicating an invite notification for each opponent.

According to at least another embodiment of the invention, wherein each opponent and the challenger belongs to a same system group, donation level and/or social media group.

According to at least another embodiment of the invention, wherein the settings further include two or more heats, each heat including at least one event.

According to at least another embodiment of the invention, wherein the donation is determined using the at least one amount and a surcharge.

According to at least another embodiment of the invention, wherein the at least two possible outcomes include a win and a loss, wherein awarding points including awarding more points to the user having a selected outcome equal to the actual outcome, and wherein the donation is associated with the user with the lesser points.

### BRIEF DESCRIPTION OF THE DRAWINGS

FIG. 1 is a schematic drawing of the system for effectuating a charitable donation according to at least one embodiment of the invention.

FIG. 2 is a schematic drawing showing a method for effectuating a charitable donation according to at least one embodiment of the invention.

FIGS. 3-18 are screenshots of the mobile application displaying system output on a mobile device of a user according to at least one embodiment of the invention.

### DETAILED DESCRIPTION OF THE INVENTION

The following description and drawings are illustrative and are not to be construed as limiting. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

The terms “nonprofit,” “charity,” and “charitable organization” can be used interchangeably herein and are given their ordinary and customary meaning and generally refer to eleemosynary organizations and legal entities such as corporations or associations defined by the state law in their respective state of formation as “nonprofit” or “not for profit” and/or which operate under United States Internal Revenue Code 501 and/or 509, or non-US jurisdictional equivalents.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a system 10. Furthermore, embodiments of the invention may take the form of a computer program product having a computer-readable storage medium having computer-executable program code embodied in the medium.

The system 10 may be implemented as a client/server architecture wherein a plurality of users 12 may communicate using their computing device with a central hub (e.g. server). The server may be a physical server or a virtual server. In other embodiments the server may be located on a company premise, or located in any other type of datacenter. The server may also be configured as a plurality of physical servers and/or virtual servers. In some embodiments, a server may provide the virtual server and may be implemented as a separated operating system (OS) running on one or more physical (i.e. hardware implemented) servers. Any applicable virtual server may by be used for the server function. The server may be implemented within a cloud computing data center environment or the like.

A computing device may be a fixed device or a mobile device. For example, a fixed device may be an interactive kiosk, a personal computer, or the like. A mobile device may be any computing device capable of being transported easily from a one location to another location without undue difficulty and one that is capable of functional connection with a remote server regardless of its location. For example a mobile device may be a smart phone, a tablet, a personal digital assistant, a laptop, or the like. In general, a computing device as used with the system 10 may be any computing device providing a user input, display, and connectivity to one or more servers over a personal area network (PAN), a local area network (LAN) and/or a wide area network (WAN). The PAN may include Bluetooth® or Universal Serial Bus (USB). The LAN may include any combination of wired Ethernet and/or Wi-Fi access points. The WAN may include the Internet and/or another wide area private network. The WAN may also include any combination of 2G, 3G, 4G, and 5G networks. In some embodiments the WAN may include Data Over Cable Service Interface Specification (DOCSIS) networks and/or fiber networks such as passive optical networks (PONs). Access to the one or more servers may also be provided via a virtual private network (VPN) within any of the previously described networks.

The system 10 may communicate with the computing devices via an app or through a website. In use, a user 12 first downloads the app or goes to the website to register and log onto the system 10. In some embodiments, the user 12 registers by creating a unique ID and/or password that identifies the user 12 in the system 10. The system 10 may be combined with mobile technology, such that a user 12 may enter the system 10 with a mobile device 208 by simply going to a website and/or opening an application 210.

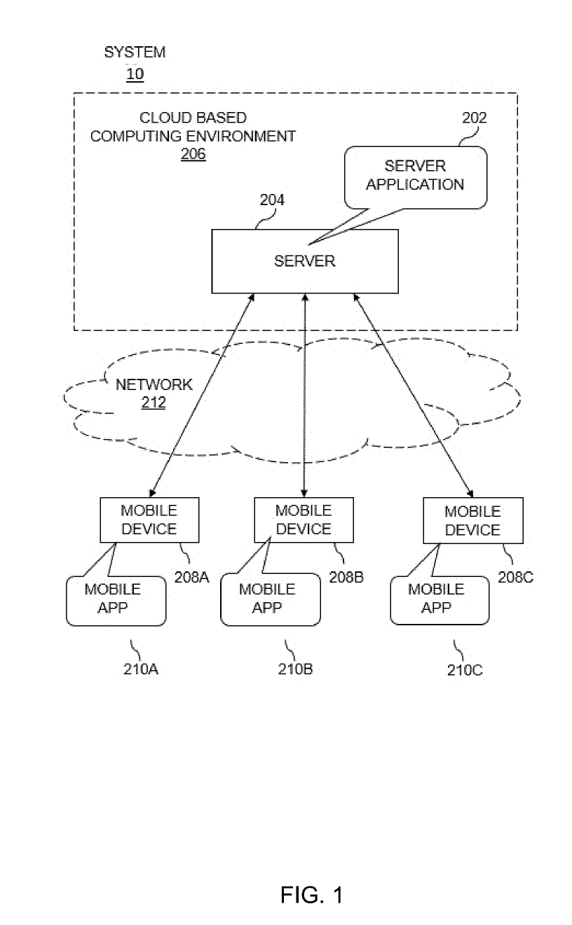

FIG. 1 depicts the system 10 in communication with a plurality of mobile devices 208, each hosting a mobile application 210 according to at least one embodiment of the system 10. Although FIG. 1 depicts the mobile devices 208 in communication with a single server 204 over a single network 212, a plurality of servers 204 and/or networks 212 may be used. The cloud based computing environment 206 may include one or more virtual servers 204 running server applications 202.

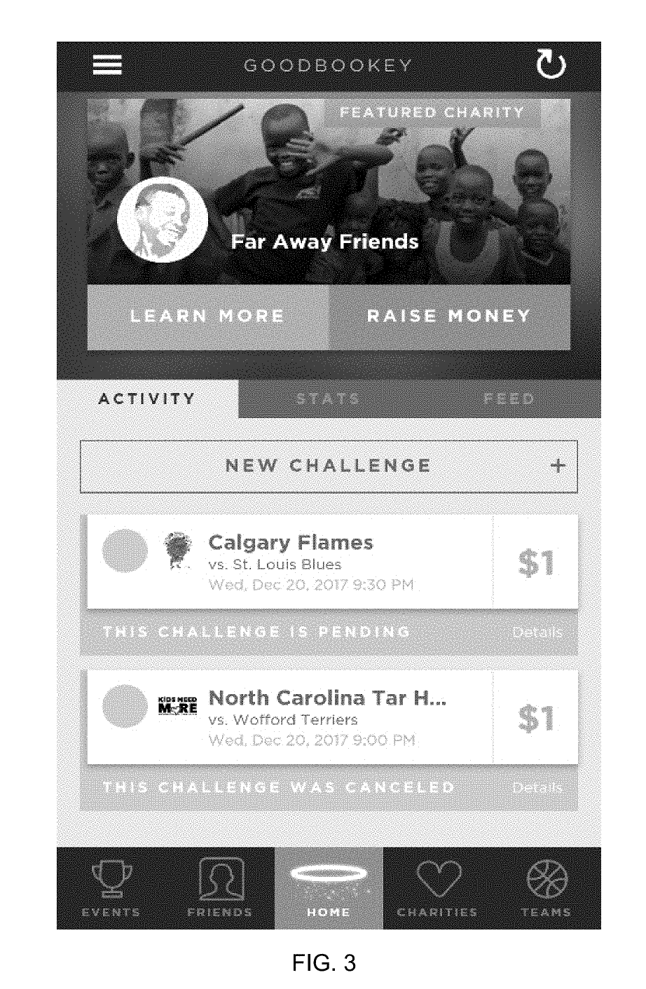

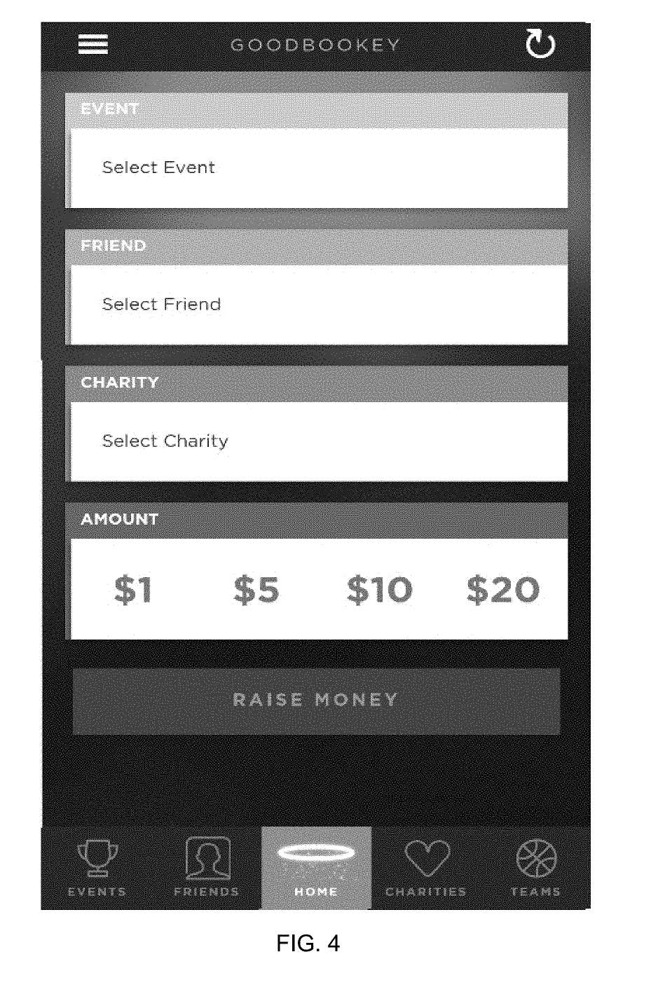

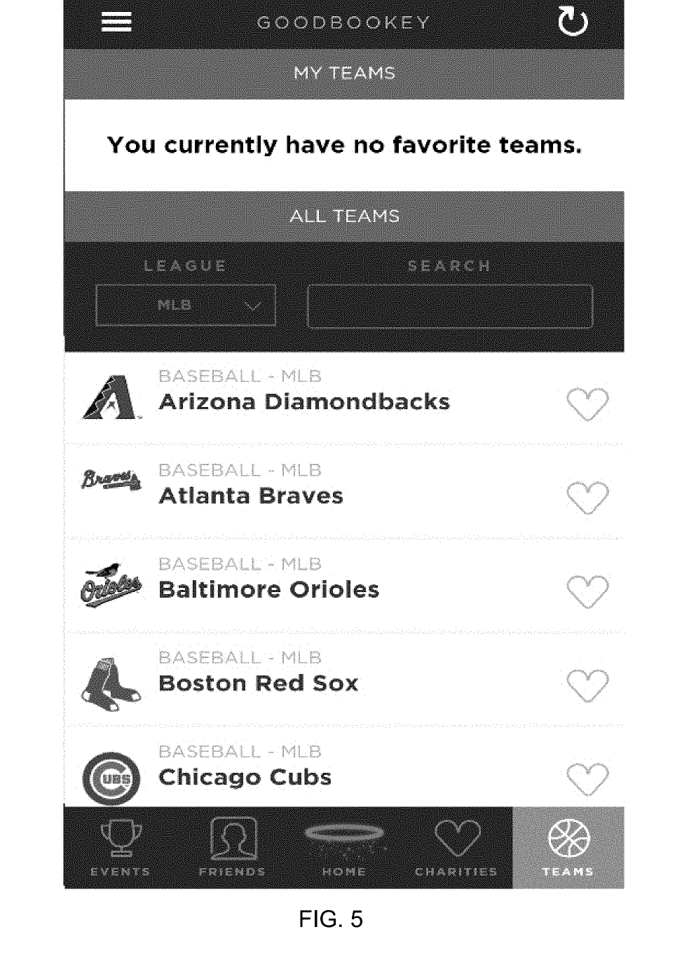

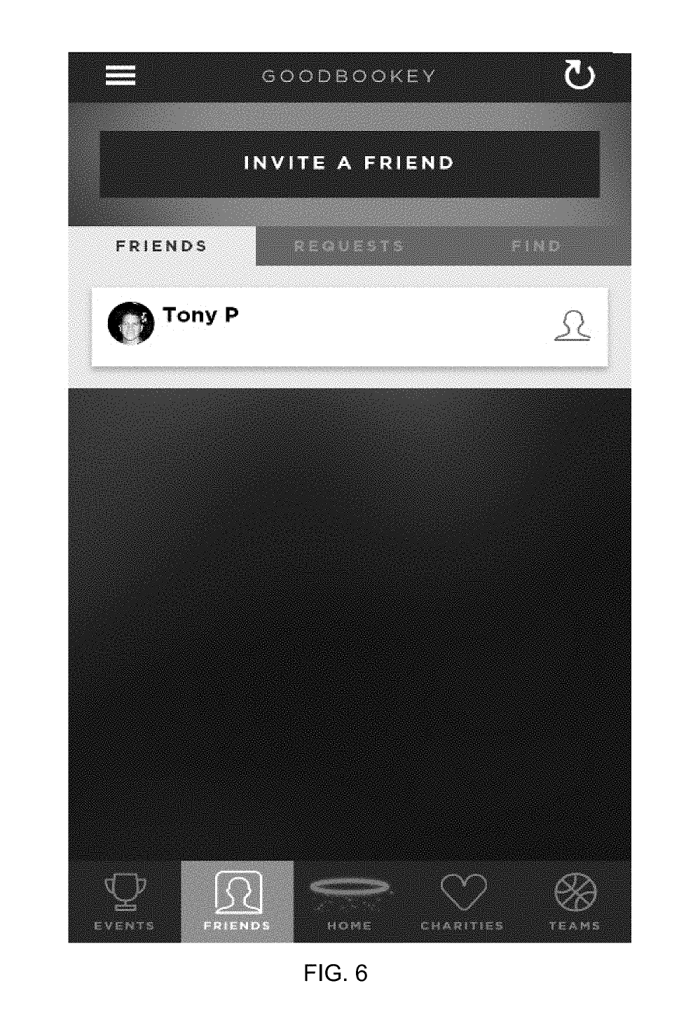

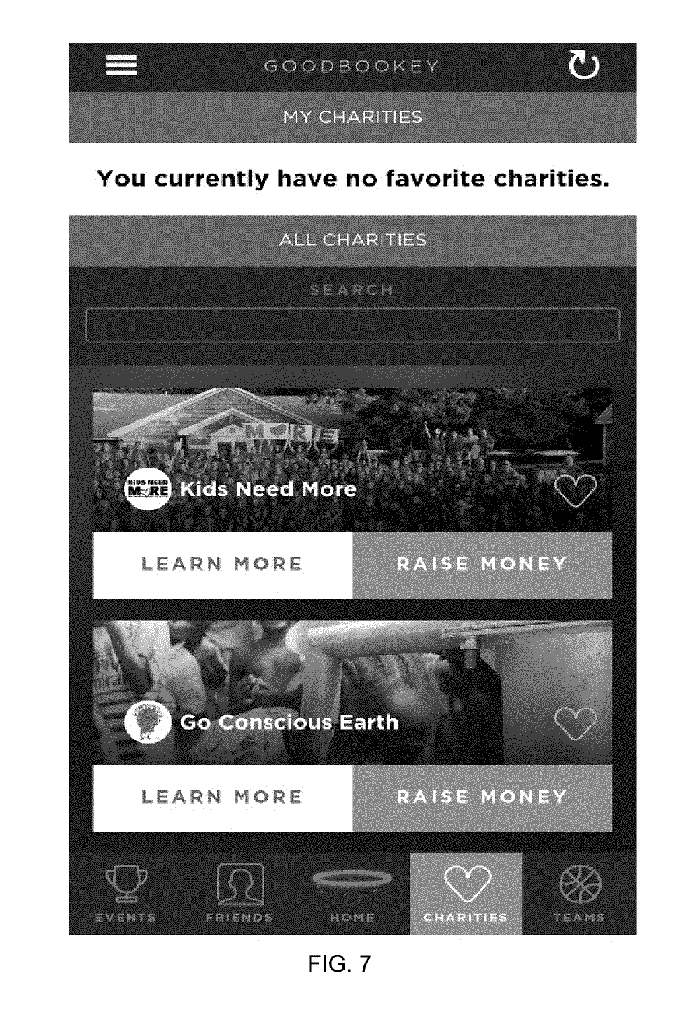

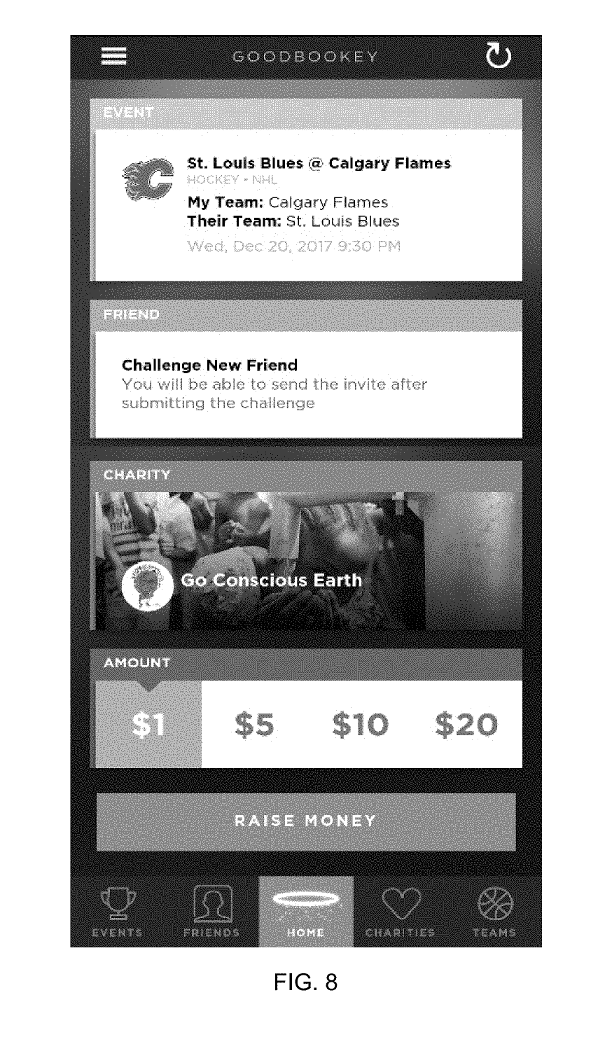

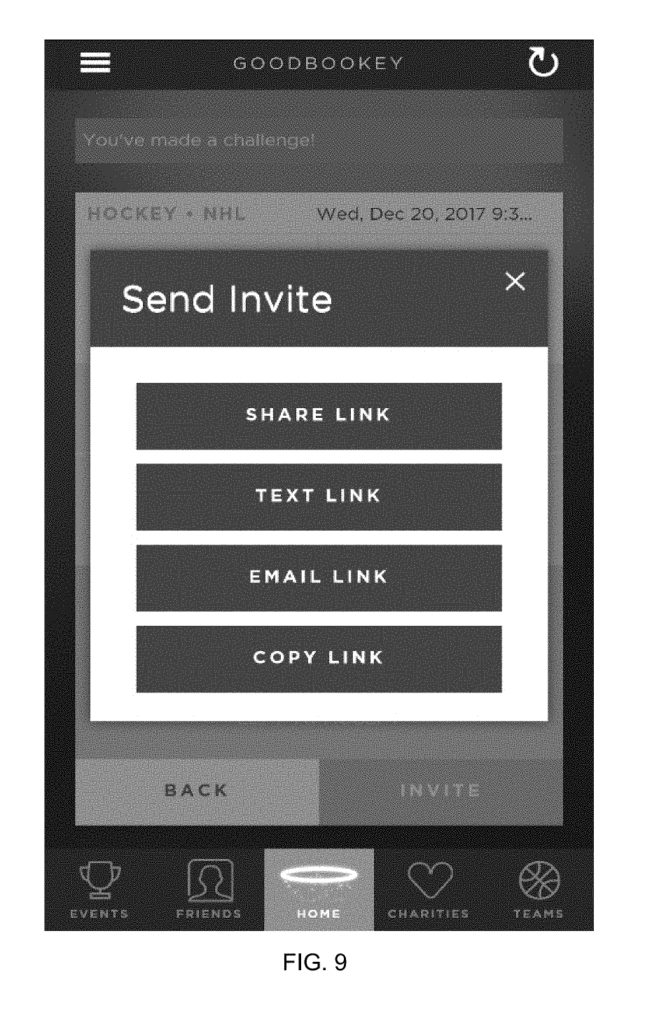

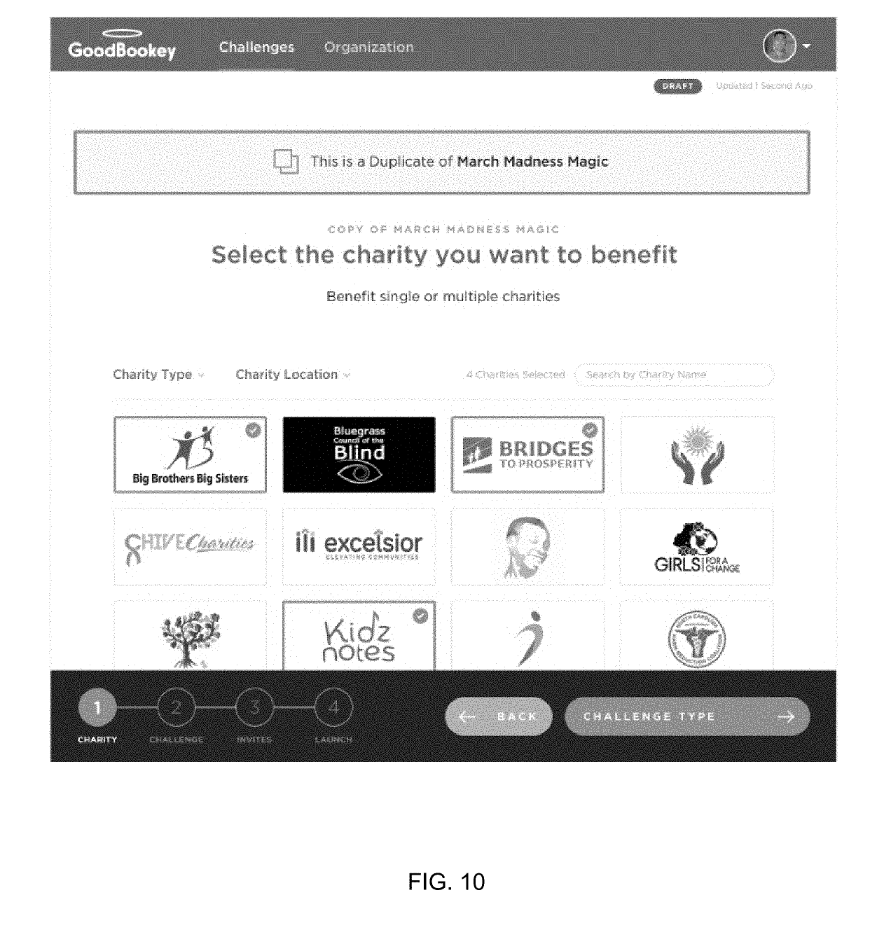

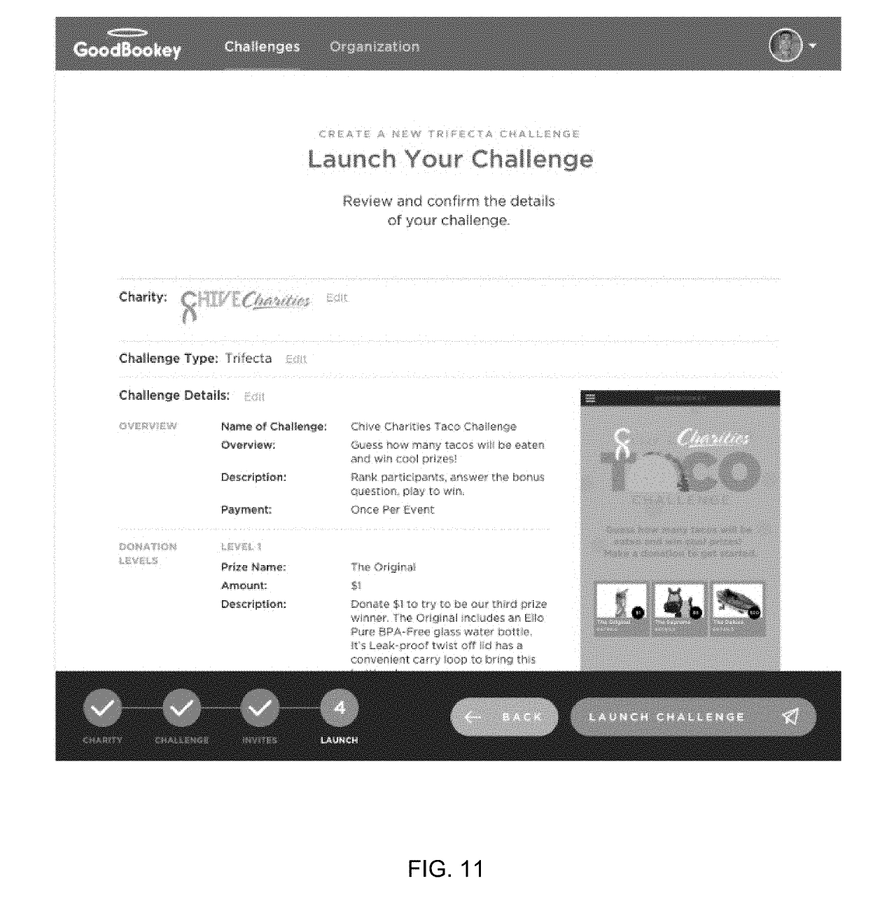

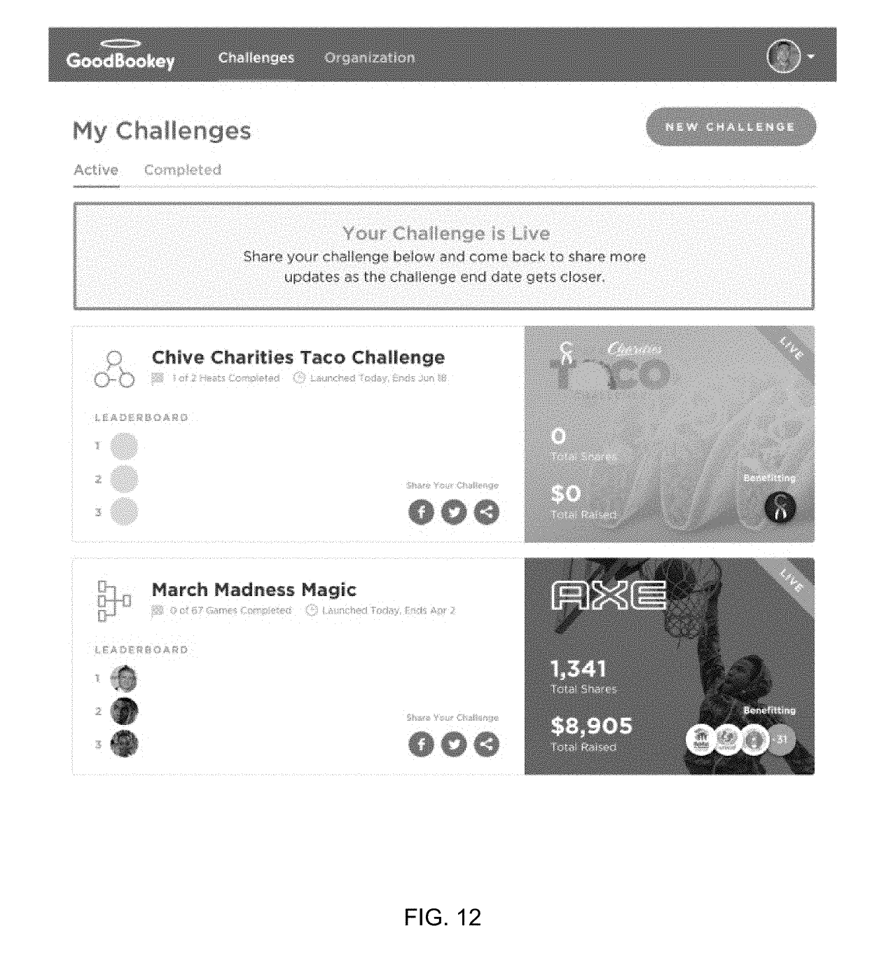

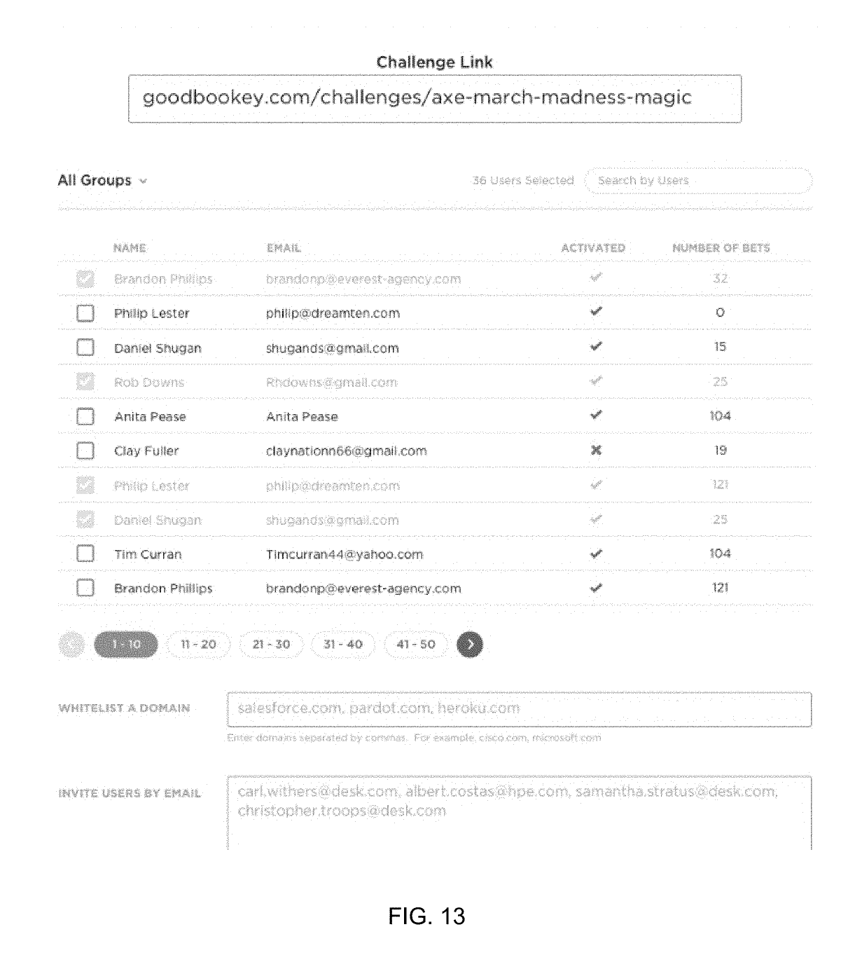

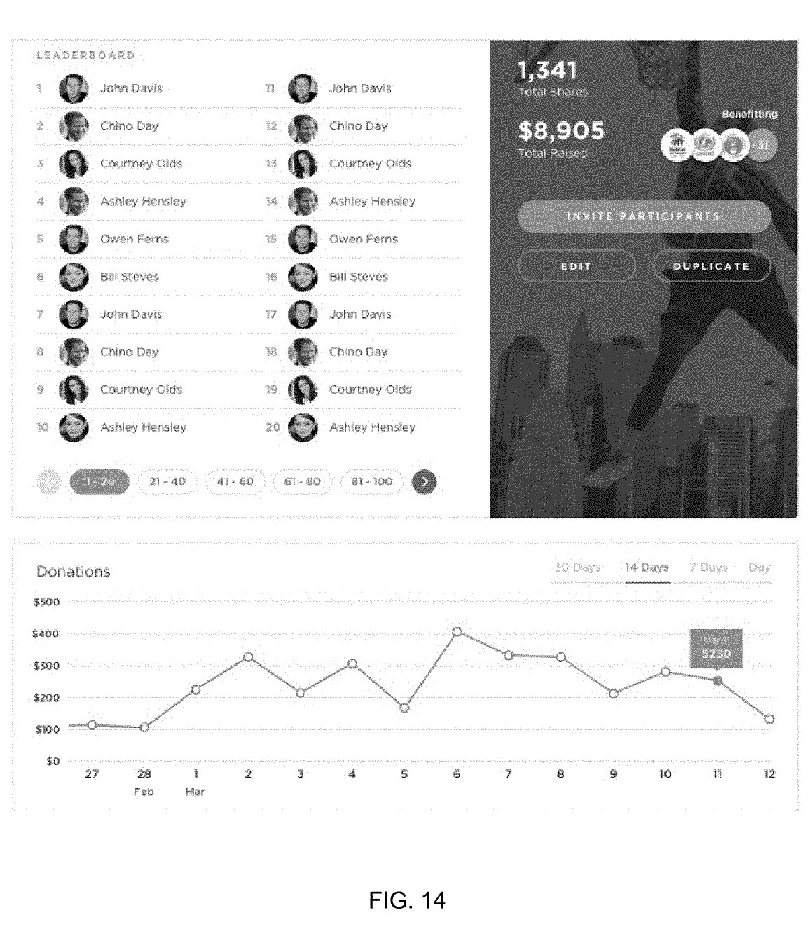

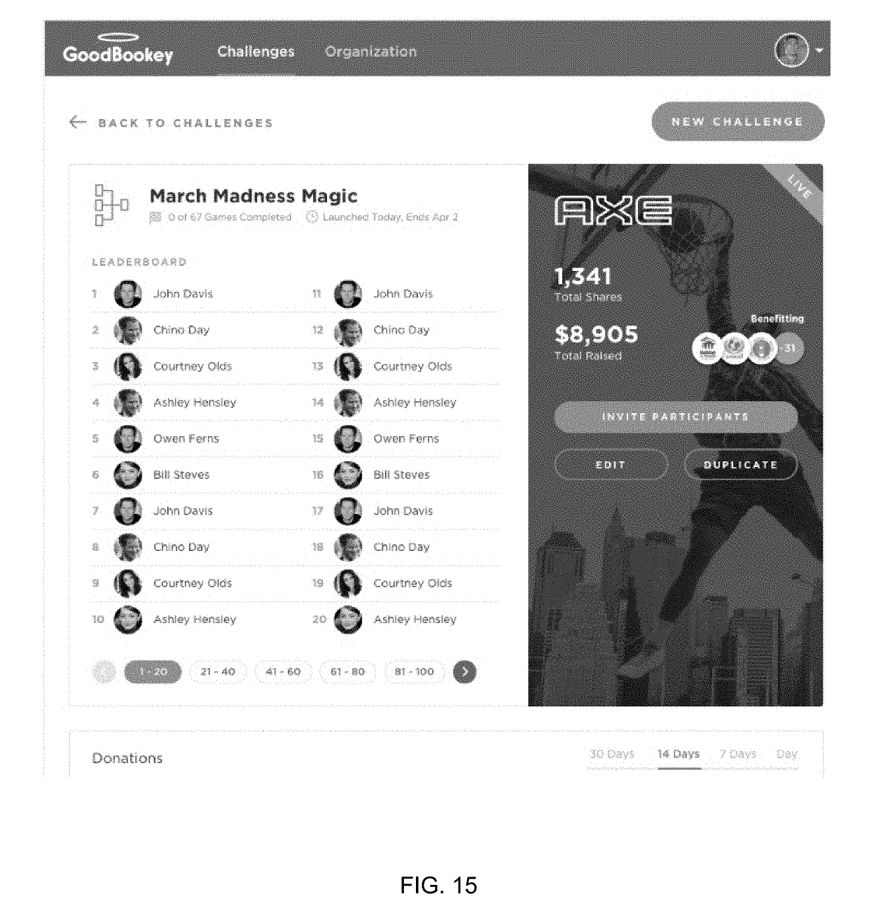

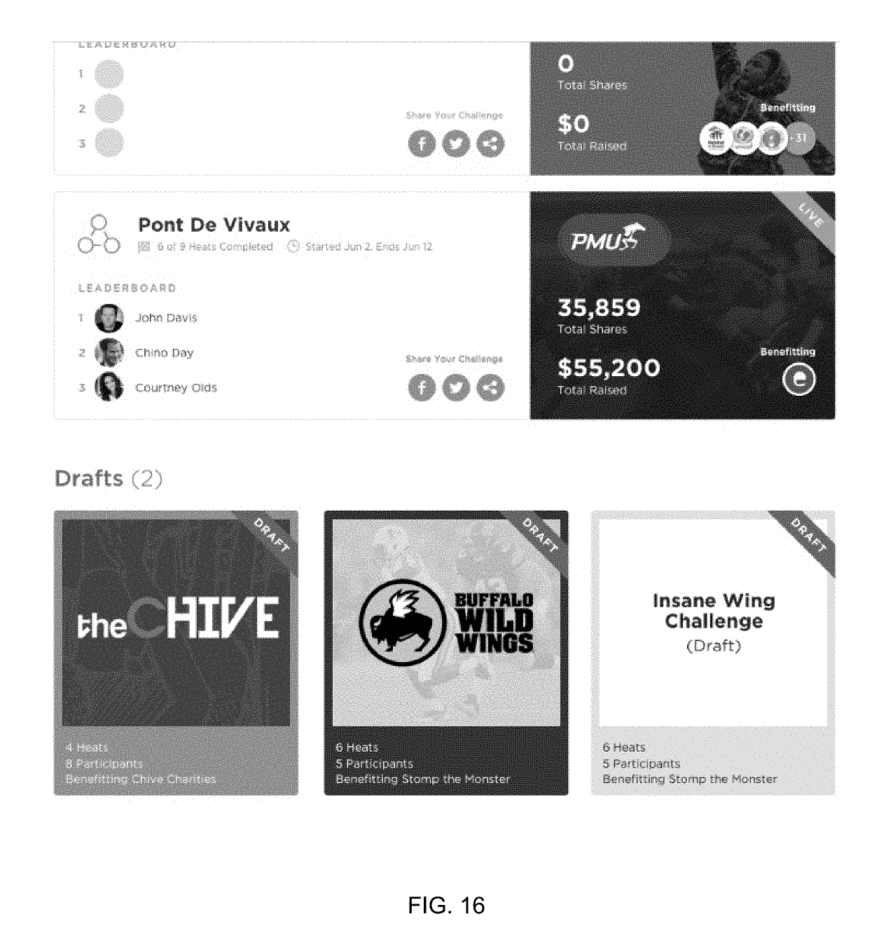

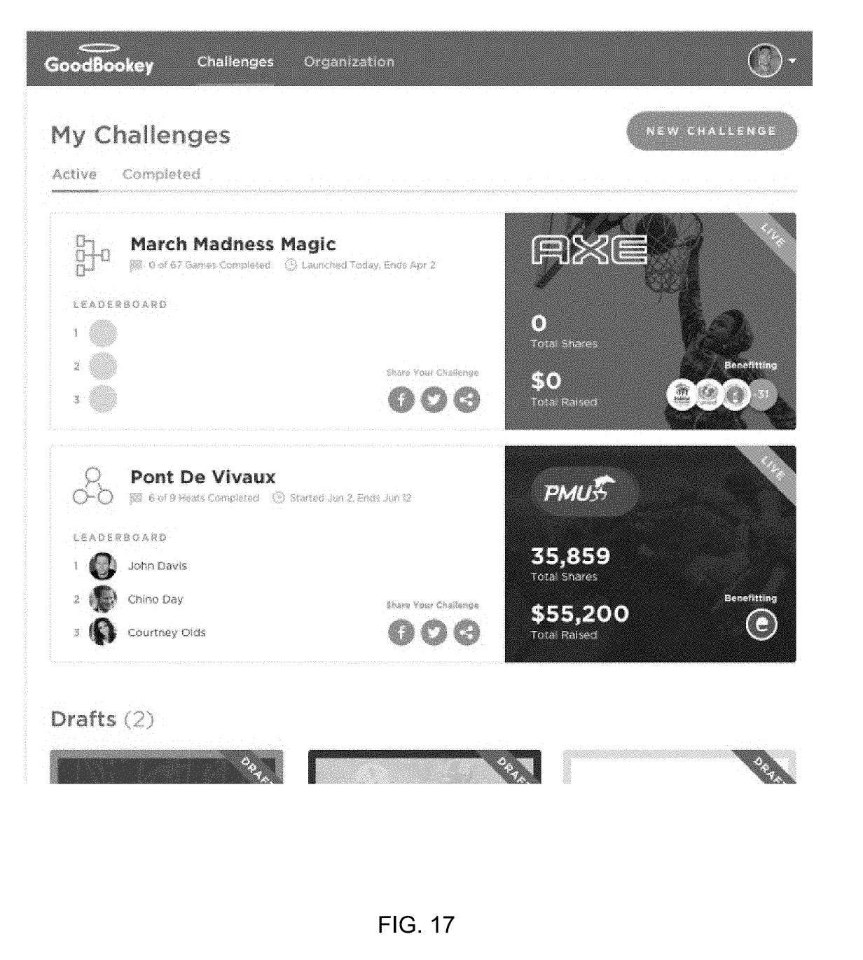

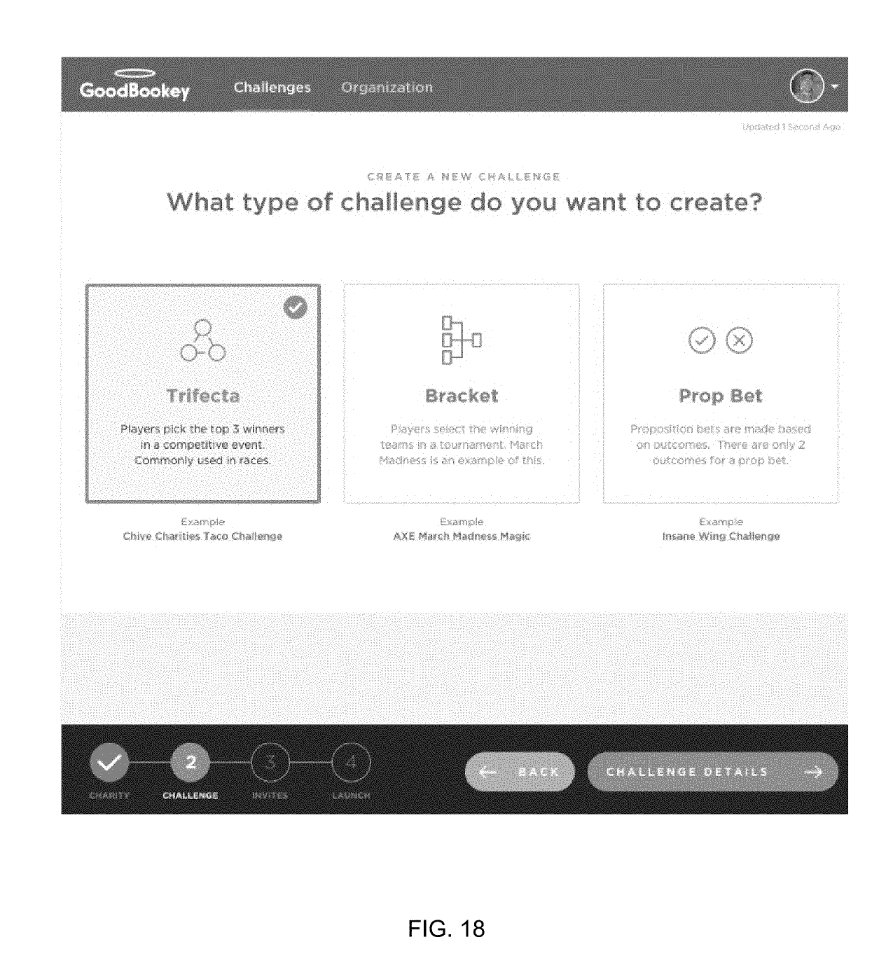

FIGS. 3-18 depict interfaces 100 of a computing device being a mobile device 208 running a mobile application 210 of the system 10 according to some embodiments of the disclosed subject matter.

System and Users. A system 10 for facilitating charitable donations 14 through the use of challenges 30 between two or more users 12 is provided. The identification(s) 20, authentication(s) 22, financial account(s) 24, and user information 26 for each user 12 may be received, stored, retrieved and/or verified by the system 10. An identification 20 may include a user name, social media account, telephone number, IP address, application or system account, biometric and/or other unique identifier of the user 12. An authentication 22 may include a password, biometric, key, handshake and/or other verifying method or information. A financial account 24 may include a credit card, bank account, payment account, cryptocurrency and/or other payment source. User information 26 may include any demographics, challenge history, scraped data or metadata or resultant data from such information related to a user 12.

The system 10 may receive and verify the identification 20 and/or authentication 22 of a user 12 via local login or through the use of third party software login. Alternatively, if the identification 20 and/or authentication 22 of a user 12 is not stored in the system 10, a new registration for the user 12 by the system 10 receiving and storing the identification 20 and/or authentication 22 of the user 12. Once logged in using verified or newly created user identification 20 and/or authentication 22, the system 10 may receive, store, validate and/or update financial account(s) 24 and/or user information 26 associated with the user 12.

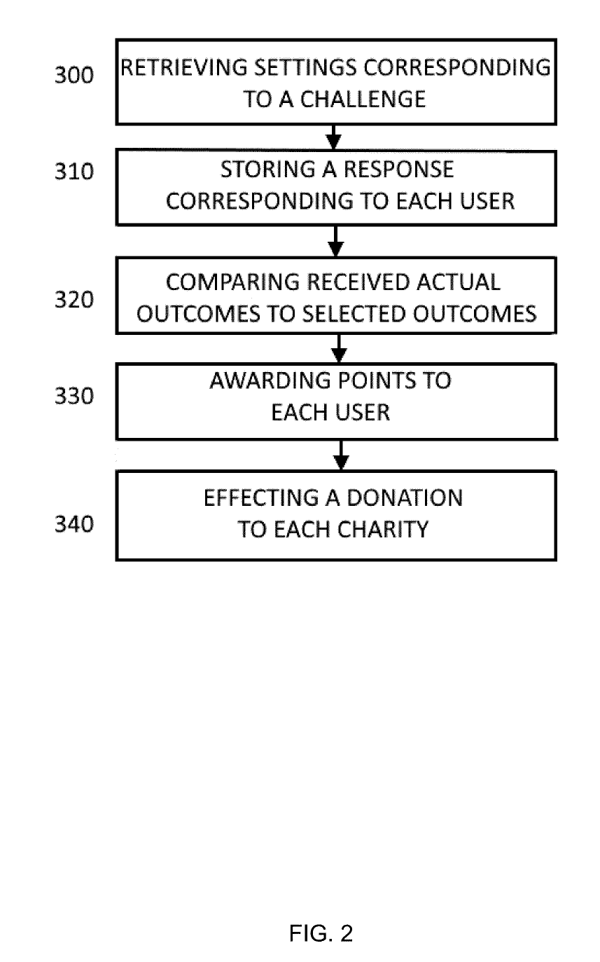

Challenge and Opponents. Referring now to FIG. 2, the system 10 may receive, store and/or verify a challenge 30 associated with a challenger 32, the challenger 32 being a user 12 who creates and/or initiates the challenge 30. Each challenge 30 may also include one or more opponents 46, each opponent 46 not being the challenger 32. The ability of certain opponents 46 to participate in a challenge 30 with the challenger 32 depends on the particular challenge 30. Each challenge 30 may be open to every user 12 of the system 10, open to every user 12 or non-user 56 of the system 10, or closed to certain users 12 of the system 10 (e.g., users 12 of a specific group, users 12 identified as belonging to a social media set of challenger 30, etc.).

For each challenge 30, the system 10 may associate a challenger 32 with one or more opponents 46. The opponents 46 may be users 12 or non-users 56. Upon receipt of a challenge 30 by the system 10, the system 10 may verify the opponents 46 as users 12 or non-users 46 by comparing the identification(s) 20, authentication(s) 22, and/or financial account(s) 24 of the opponents 46 to the users 12. The system 10 may communicate a notification 72 for initiating registration of the non-user 56 into a user 12.

Not only may challenges 30 be open or closed to certain opponents 46, but challenges 30 may be one of several format types, including, but not limited to, a trifecta 50, a bracket 52 and a prop bet 54. Using the systems and methods described herein, one skilled in the art may be able to create numerous other challenge types.

Event. For each challenge 30, the system 10 may further receive at least one event or set of events 34 associated therewith. An event 34 may be a set of events 34, actual sporting event(s) or competition(s), or newly envisioned or created sporting event(s) or competition(s). Events 34 may also include other scenarios in which two or more outcomes is possible (e.g., the number of marbles in a jar, the speed at which a cheetah may run, whether the temperature will be above or below eighty degrees Fahrenheit tomorrow, etc.). In some embodiments, the challenge 30 may be limited to a single particular event 34 (e.g., college football game, wing-eating competition, marathon, etc.) or a particular set of events 34 (e.g., basketball playoffs, spelling bee, etc.). In other embodiments, the challenge 30 may be open to all events 34. Each event 34 may be a known event or set of events 34K previously known, verified and/or stored by the system 20 or may be a new event or set of events 34N received by the system 10. Each new event 34N may be verified by the system 10.

Possible Outcomes. For each challenge 30 and/or event 34, there may be one or more possible outcomes 36 associated therewith, the outcomes 36 being received or retrieved by the system 12. For example, a prop bet challenge 54 may include a single event 34 having only two possible outcomes 36 (e.g., team A competing with team B having two possible outcomes: either A wins or B wins). In another example, a trifecta challenge 50 may include a single event 34 having at least six possible outcomes (e.g., persons X, Y and Z competing, having six possible outcomes where the persons win in the following order: XYZ, XZY, YXZ, YZX, ZXY, ZYX).

Heats. For each challenge 30 and/or event 34, there may be one or more heats 40 associated therewith. A challenge may include several heats 40, each heat having one or more events 34 and two or more possible outcomes 36 per event 34. In one example, a bracket challenge 52 may include two first events 34, each having two possible outcomes 36, followed by one second event 34 having two possible outcomes 36 (e.g., teams K and L and teams M and N compete in the first heat 40 having two events 34, teams K and M both win, then compete against each other in the second heat 40 having a single event 34).

Charity. For each challenge 30, event 34, and/or heat 40, the system 10 may further receive, assign and/or associate at least one charity 42 therewith. Each charity 42 may be an known charity 42K previously known, verified and/or stored by the system 10 or may be a new charity 42N received by the system 10. Each new charity 42N may require verification by the system 10.

Amount. For each challenge 30, event 34, heat 40 and/or charity 42, the system 10 may further receive, assign and/or associate at least one amount 44 therewith. For example, a bracket challenge 52 may be received, retrieved or created by the system 10, associating a first charity 42 and a first amount 44 with the first heat 40 of the two first events 34, and a second charity 42 and a second amount 44 with the second heat 40 of the second event 34. In another example, a prop bet challenge 54 may be received, retrieved or created, associating a first event 34 with both a first charity 42 and a first amount 44, and a second charity 42 and a second amount 44, permitting users 12 to choose between the two.

GUI. The system 10 may display any information on a graphic user interface (GUI) 100 that may be viewable, partially or wholly, by users 12, challengers 32, opponents 46 and/or non-users 56.

Pending Challenges. Upon verification or registration of the challenger 32 and one or more opponents 46, the system 10 may save or store the challenge 30 as an pending challenge 62. A challenge 30, once it becomes an pending challenge 62, may be displayed on a GUI 100 and viewable by any challenger 32 and/or opponent 46 associated with the pending challenge 62. In some embodiments, the challenge 30 may be publicly displayed and viewable by a non-user 56 and/or other users 12 not considered challengers 32 nor opponents 46.

Challenge Settings. Each challenge 30 may be stored in the system 10, and updated in the system 10 as any associated event 34, outcome 36, heat 40, charity 42, amount 44, opponent 46, type 50, 52, 54, or other setting (collectively settings 74) is verified, updated, suggested and/or requested. The system 10 may receive and/or store in the settings 74 of the challenge 30, in relation to an pending challenge 62, an acceptance 64, a decline 66 and/or a modification 70 corresponding to each of the two or more users 12 of the challenge 30.

In some embodiments of the system 10, a challenge 30 is created and/or initiated by a challenger 32 or the system 10 itself The challenge 30 may be closed and limited to certain users 12 and/or non-users 56 or open to all, as has been described. The challenge 30 may be retrieved by a search and/or displayed and viewable within a category of challenges 30 (e.g., today's challenges, sports challenges, challenges pending for group X, etc.). The challenge 30 may also be communicated by the system 10 in a notification 72. The notification 72 may be displayed on a GUI 100, for example a home page or group page, or may be communicated to certain users 12 and/or non-users 56 (e.g., the users 12 of a group to which the challenge 30 is limited).

Upon viewing a challenge 30, or notification of a challenge 30, if a user 12 and/or non-user 56 is qualified to join the challenge as an opponent 46, the system may register an acceptance 64, a decline 66 or a request for modification 70 associated with the user 12 and/or non-user 56. Acceptance 64 of a challenge 30 may register the user 12 as an opponent 46 of the challenge 30. Acceptance 64 of a challenge 30 may register a non-user 56 as an opponent 46 of the challenge 30, or may require that the non-user 56 register to become a user 12 before becoming an opponent 46 of the challenge 30.

Any lack of acceptance 64 associated with a user 12 and/or non-user 56, and/or any failure to register by a non-user 56, may be stored in the settings 74 of the challenge 30 as a decline 66 by the user 12 and/or non-user once a specific time has passed or has been reached (e.g., an hour before the start time of the first event 34), and/or upon association of acceptance 64 from a certain number of users 12 and/or non-users 56 with the corresponding challenge 30. The specific time(s) and certain number of users 12 may be stored in settings 74 relating to all, some or a particular challenge 30 of the system 10. Upon receipt of the acceptance 64, decline 66 and/or modification 70, the system 10 may update the settings 74 of the challenge 30 and communicate a notification 72 viewable by the users 12 associated with the challenge 30 for updating the user of the changes.

In some embodiments, a challenge 30 may be modified by users 12, non-users 56, opponents 46 and/or the challenger 32. In one example, user 12, before accepting a challenge 30, may request to modify or be qualified to modify immediately, a charity 42 or amount 44 associated with a challenge 30 (e.g., adding a new charity 42 or lowering the amount 44). In another example, an opponent 46 may request to raise the amount 44 of one, some or all events 34 of a challenge 30. The modification 70 may take effect immediately, be approved or disapproved by the challenger 32 or system 10, or may be approved or disapproved by a number of users 12, non-users 56, opponents 56 and/or the challenger 32. The settings 74 of the challenge 30 may dictate the rules governing modifications 70 and acceptance or denial of modifications 70. Notifications 72 may be created and/or communicated by the system 10 upon receipt, acceptance and/or denial of any modification 70.

Although some challenges 30, heats 40, events 34 and/or charities 42 may be associated with a single amount 44 according some embodiments, other embodiments may permit differing amounts 44 with any challenge 30, heat 40, event 34 and/or charity 42. In one example a challenge 30 may permit opponents 46 to participate at two different amounts 44 or donation levels, effectively creating two, separate challenges 30 having similar settings 74, notwithstanding the amount 44, of course. A single challenger 32 or opponent 46 may participate in the challenge 30 at both donation levels or amounts 44, or choose one amount 44 with which to participate.

Each challenge 30 created, stored or pending permits customized gamification and competition of an event or events 34 between a challenger 32 and/or opponent(s) 46 resulting in donations 96 to a charitable causes 42 relating to the one or more amount(s) 44 involved. The system 10 may collect charitable donations 96 relative to the amount(s) 44 involved in the challenge(s) 30 upon acceptance 64 of the challenge 30, after acceptance 64 but during the pendency 62 of the challenge 30, heat 40 and/or event 34, after the challenge 30, heat 40 and/or event 34 becomes active 68, and/or after the challenge 30, heat 40 and/or event 34 becomes completed 69. In some embodiments, the donation 96 is collected when a specific donation level is reached for a user 12, non-user 56, charity 42, challenge 30, heat 40, and/or event 34.

Alternatively, the system 10 may effectuate or direct a donation 96, as opposed to collecting the donation 96. One or more service charges 98 may be collected by the system 10 from one or more donations 96 or may be collected in addition to one or more donations 96. A service charge 98 may be charged, in effect, to the charity 42 similar to the charging of a credit card processing charge 98 to a retailer.

Active challenges 68 are challenges 30 which have at least one event 34 which has begun and at least one event 34 which has not yet ended; the events 34 may be the same events 34. A notification 70 may be created, displayed and/or communicated to select or all users 12 and/or non-users 56 upon completion of each event 34, heat 40, challenge 30 and/or milestone within each event 34 (e.g., halftime, outcome 36, period, quarter, etc.). The notification 70 may be in the form of a real-time update or status tracker displayed on the GUI 100.

Points 82 may be awarded to each user 12, challenger 32, and/or opponent 46. Points 82 may be awarded at intervals during an event 34, heat 40, and/or challenge 30. Points 82 may be awarded based on one or more outcomes 36, one or more completed challenges 69, the ranking or donation level of the user 12, challenger 32 and/or opponent 46, and/or the win percentage of the user 12, challenger 32 and/or opponent 46. Points may be awarded based on the timeliness of one or more donations 96, the completion rate of one or more donations 96, and/or the total of one or more donations 96.

Points 82 may be used to create a leaderboard, the leaderboard including one or more users 12 of challenge 30 or group of users 12 (e.g., any of the groupings herein, such as social media contacts, or characteristics 84 of the users 12). In some challenges 30, points 82 are used to determine which of the users 12 win or proceed to the next heat 40. Further, points 82 may be used to determine which users 12 are awarded prizes 94 or whether certain prizes 94 are unlocked. In some embodiments, points 82 and/or prizes 94 may be purchased through the system 10. In other embodiments, prizes 94 may be awarded or unlocked separately for each donation level 44. Other data collected relative to each user 12 or group of users 12 can be used by the system 10 to unlock prizes, such as average wins, payment times, number of challenges 30 or events 34 created or participated, and/or other data collected by the system 10.

The system 10 may include a random generator for breaking any ties between points 82 of users 12 or in challenges 30 in which users 12 are participating. In some embodiments, instead of a random generator being used, the system 10 may collect and store additional data related to the challenge 30, heat 40 and/or event 34 (e.g., total score of winning team, final score for both teams, stats for teams or players or events, weather, etc.).

The system 10 may enable messaging between users 12. Messaging groups may include only users 12 participating in certain groups, events 34, heats 40 and/or challenges 30. In some embodiments messaging groups may include users 12 having a certain level of points 82, or participating at a certain donation level 44.

In some embodiments, users 12 participating in a challenge 30 may create one-on-one direct challenges, also known as propositional challenges, directly with each other using the system 10. For example, a challenge 30 for a eight team basketball tournament may include four users 12; two of the users 12 may make propositional challenges within the tournament challenge 30 with each other. The propositional challenge may include an outcome of a single event 34 or heat 40, or may include any other data collected by the system 12.

Challenges 30, events 34, heats 40, users 12 and/or outcomes 36 may be handicapped according to the setting 74. Although the system 10 or a challenger 32 may set the handicap of an event 34, for example, one or more users 12 or opponents 46 may request to modify the handicapping of the event 34. In one example, the system 10 may handicap the outcome(s) 36 of a challenge according to the lines or predicted outcomes provided by a third party.

The system 10 may provide challenge 30, charity 42, user 12 and/or donation level 44 recommendations based on stored, collected or analyzed data related to a user 12, such as user's history with the system 10, and/or sentiment analysis using social media and other real-time analyzations.

Particular embodiments and features have been described with reference to the drawings. It is to be understood that these descriptions are not limited to any single embodiment or any particular set of features. and that similar embodiments and features may arise or modifications and additions may be made without departing from the scope of these descriptions and the spirit of the appended claims.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server.

Aspects of the present invention are described in the instant specification with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The invention claimed is:

1. A method of effecting a charitable donation comprising:
retrieving settings corresponding to a challenge, the settings including a challenge type, at least one event each having at least two possible outcomes, at least one charity, and at least one amount;
storing a response corresponding to each of at least two users, at least two responses including an acceptance of the challenge, a selection of one of the at least two possible outcomes and a selection of another of the at least two possible outcomes;
comparing at least one received actual outcome to each selected outcome, wherein the at least one actual income is one of the at least two possible outcomes;
awarding points to each of the users based on the comparing; and
effecting a donation to one of the at least one charity based on the awarding.

2. The method of claim 1, further comprising:
identifying one of the at least two users as a challenger and each remaining users as an opponent;
modifying the settings using responses associated with the challenger; and
communicating an invite notification for each opponent.

3. The method of claim 2, wherein each opponent and the challenger belongs to a same system group, donation level and/or social media group.

4. The method of claim 1, wherein the settings further include two or more heats, each heat including at least one event.

5. The method of claim 1, wherein the donation is determined using the at least one amount and a surcharge.

6. The method of claim 1, wherein the at least two possible outcomes include a win and a loss, wherein awarding points including awarding more points to the user having a selected outcome equal to the actual outcome, and wherein the donation is associated with the user with the lesser points.

7. A server for effecting a charitable donation comprising, the server comprising:
a memory; and
at least one processor configured for:
retrieving settings corresponding to a challenge, the settings including a challenge type, at least one event each having at least two possible outcomes, at least one charity, and at least one amount;
storing a response corresponding to each of at least two users, at least two responses including an acceptance of the challenge, a selection of one of the at least two possible outcomes and a selection of another of the at least two possible outcomes;
comparing at least one received actual outcome to each selected outcome, wherein the at least one actual income is one of the at least two possible outcomes;
awarding points to each of the users based on the comparing; and
effecting a donation to one of the at least one charity based on the awarding.

8. The server of claim 7, wherein the at least one processor is further configured for:
identifying one of the at least two users as a challenger and each remaining users as an opponent;
modifying the settings using responses associated with the challenger; and
communicating an invite notification for each opponent.

9. The server of claim 7, wherein each opponent and the challenger belongs to a same system group, donation level and/or social media group.

10. The server of claim 7, wherein the settings further include two or more heats, each heat including at least one event.

11. The server of claim 7, wherein the donation is determined using the at least one amount and a surcharge.

12. The server of claim 7, wherein the at least two possible outcomes include a win and a loss, wherein awarding points including awarding more points to the user having a selected outcome equal to the actual outcome, and wherein the donation is associated with the user with the lesser points.
